(19) United States
(12) Patent Application Publication
(10) Pub. No.: US 2024/0090031 A1
(43) Pub. Date: Mar. 14, 2024

(54) UNLICENSED BAND USAGE BY BOTH UNLICENSED RADIO TECHNOLOGY AND A HIGHER PRIORITY RADIO TECHNOLOGY

(71) Applicant: Telefonaktiebolaget LM Ericsson (publ), Stockholm (SE)

(72) Inventors: Ralf Schuh, Lund (SE); David Sugirtharaj, Lund (SE); Narendar Madhavan, Bara (SE)

(21) Appl. No.: 18/275,673

(22) PCT Filed: Feb. 8, 2021
(86) PCT No.: PCT/EP2021/052979

§ 371 Date: Aug. 3, 2023

(51) Int. Cl. H04W 74/08; H04L 5/14

(52) U.S. Cl. CPC H04W 74/0816; H04L 5/14

(57) ABSTRACT

Systems and methods are disclosed herein that enable protecting a higher priority radio technology (e.g., 3GPP New Radio (NR) or NR in Unlicensed spectrum (NR-U)) when co-existing with an unlicensed radio technology (e.g., the Wi-Fi wireless network technology) operating in the same frequency band. In one embodiment, a method of operation of a radio access node of radio access network of a cellular communications system comprises transmitting a Request to Send (RTS) frame within a Time Division Duplexing (TDD) radio frame on a cell served by the radio access node in an unlicensed frequency band. The method further comprises transmitting a downlink transmission to a wireless communication device or receiving an uplink transmission from the wireless communication device, on the cell served by the radio access node in the unlicensed spectrum during a period of time that corresponds to a duration of time indicated in the RTS frame.

### TECHNICAL FIELD

The present disclosure relates to co-existing of both licensed and unlicensed radio technologies in the same frequency band, or overlapping frequency bands, where the licensed radio technologies support higher output power and support applications like Ultra-Reliable Low Latency Communication (URLLC) applications.

### BACKGROUND

In the future, both licensed usage (local area, light licensing, etc.) and unlicensed usage (country wide) may occur in the same frequency band. For example, in the 66-71 Gigahertz (GHz) frequency band, which at the World Radiocommunication Conference (WRC) held in 2019 was identified for International Mobile Telecommunications (IMT) usage and at the same time is already specified for unlicensed Short Range Device (SRD) usage in Europe and the United States of America (USA). Another example is the current 6 GHz frequency band in Europe where the Wi-Fi suite of wireless network protocols (i.e., the Institute of Electrical and Electronics Engineers (IEEE) 802.11 wireless network protocols) and cellular network protocols can use adjacent spectrum or the same spectrum. The Wi-Fi suite of wireless network protocols are the dominating protocols in devices using unlicensed spectrum.

Spectrum is rare and the general trend is the usage of spectrum without guard bands to adjacent services or the sharing of spectrum for different services. Ultra-Wideband (UWB) is one example if a radio technology that uses a large amount of spectrum at very low power levels as a lower tier service in a limited area without protection. Another example is unlicensed SRDs, which may operate in the duplex gap of licensed Frequency Division Duplexing (FDD) bands or adjacent to a Time Division Duplexing (TDD) band or share the same frequency band with IMT systems (e.g., Long Term Evolution (LTE) Licensed Assisted Access (LAA) or New Radio in Unlicensed spectrum (NR-U)). Such systems in unlicensed bands normally use TDD. In the unlicensed frequency band, LTE LAA and NR-U cannot fulfil Quality of Service (QoS) demands, unlike LTE and NR in the licensed frequency band case.

For cellular TDD bands, synchronization is one key enabler for not requiring guard bands between operators in the same frequency band. This is usually within the license rules or can be agreed between the operators in a frequency band. For unlicensed operation, this is not possible as any entity could deploy and use the frequency band. The synchronization between licensed or unlicensed could also be semi-synchronized like discussed in cellular TDD systems where only parts of the downlink (DL)/uplink (UL) frame need to be synchronized, see e.g. ECC Report 281, Analysis of the suitability of the regulatory technical conditions for 5G MFCN operation in the 3400-3800 MHz band, July 2018.

Unlicensed bands may not be able to fulfil Industrial Internet of Things (IoT) QoS requirements with very strict delay and reliability. Thus, in areas in which IoT usage is desired, licensed usage needs to be secured.

### SUMMARY

Systems and methods are disclosed herein that enable protecting a higher priority radio technology (e.g., Third Generation Partnership Project (3GPP) New Radio (NR) or NR in Unlicensed spectrum (NR-U)) when co-existing with an unlicensed radio technology (e.g., the Wi-Fi wireless network technology) operating in the same frequency band. In one embodiment, a method of operation of a radio access node of radio access network of a cellular communications system comprises transmitting a Request to Send (RTS) frame within a Time Division Duplexing (TDD) radio frame on a cell served by the radio access node in an unlicensed frequency band. The method further comprises transmitting a downlink transmission to a wireless communication device or receiving an uplink transmission from the wireless communication device, on the cell served by the radio access node in the unlicensed spectrum during a period of time that corresponds to a duration of time indicated in the RTS frame. In this manner, transmissions of the radio technology utilized for the cell served by the radio access node can be protected from unlicensed radio technology when sharing the same frequency spectrum.

In one embodiment, the duration of time indicated in the RTS frame is less than a length of the TDD radio frame on the cell served by the radio access node. In one embodiment, the method further comprises selecting data for transmission during the period of time that corresponds to the duration of time indicated in the RTS frame based on priority, wherein the downlink transmission or the uplink transmission is a transmission of the selected data. In one embodiment, the selected data is data for an Ultra-Reliable Low-Latency Communication (URLLC) service.

In one embodiment, the duration of time indicated in the RTS frame is equal to a length of the TDD radio frame on the cell served by the radio access node.

In one embodiment, transmitting the RTS frame within the TDD radio frame comprises transmitting the RTS frame within a special slot of an uplink/downlink frame structure of the TDD radio frame. In another embodiment, transmitting the RTS frame within the TDD radio frame comprises transmitting the RTS frame within a guard period within a special slot of an uplink/downlink frame structure of the TDD radio frame. In one embodiment, the method further comprises receiving a Clear to Send (CTS) frame during the special slot, wherein transmitting the downlink transmission to the wireless communication device or receiving the uplink transmission from the wireless communication device comprises transmitting the downlink transmission to the wireless communication device or receiving the uplink transmission from the wireless communication device responsive to receiving the CTS frame during the special slot.

In one embodiment, the method further comprises transmitting one or more additional RTS frames within one or more additional TDD radio frames on the cell served by the radio access node in the unlicensed frequency band.

In one embodiment, the method further comprises periodically transmitting one or more additional RTS frames within one or more additional TDD radio frames on the cell served by the radio access node in the unlicensed frequency band.

In one embodiment, the method further comprises periodically transmitting one or more additional RTS frames within one or more additional TDD radio frames on the cell served by the radio access node in the unlicensed frequency band at a particular periodicity, wherein the particular periodicity is based on an amount of data of a first priority that is to be or expected to be transmitted on the cell and/or an amount of data of a second priority that is to be or expected to be transmitted on the cell, the first priority being higher than the second priority.

In one embodiment, the RTS frame is an IEEE 802.11 RTS frame.

Corresponding embodiments of a radio access node are also disclosed. In one embodiment, a radio access node for a radio access network of a cellular communications system is adapted to transmit a RTS frame within a TDD radio frame on a cell served by the radio access node in an unlicensed frequency band. The radio access node is further adapted to transmit a downlink transmission to a wireless communication device or receive an uplink transmission from the wireless communication device, on the cell served by the radio access node in the unlicensed spectrum during a period of time that corresponds to a duration of time indicated in the RTS frame.

In another embodiment, a radio access node for a radio access network of a cellular communications system comprises processing circuitry configured to cause the radio access node to transmit a RTS frame within a TDD radio frame on a cell served by the radio access node in an unlicensed frequency band. The processing circuitry is further configured to cause the radio access node to transmit a downlink transmission to a wireless communication device or receive an uplink transmission from the wireless communication device, on the cell served by the radio access node in the unlicensed spectrum during a period of time that corresponds to a duration of time indicated in the RTS frame.

Embodiments of a computer program are also disclosed in which the computer program comprises instructions which, when executed on at least one processor, cause the at least one processor to carry out the method of operation of a radio access node in accordance with any of the embodiments disclosed herein. Embodiments of a carrier containing the computer program are also disclosed, wherein the carrier is one of an electronic signal, an optical signal, a radio signal, or a computer readable storage medium.

In one embodiment, a non-transitory computer readable medium is provided, wherein the non-transitory computer readable medium comprises instructions executable by processing circuitry of a radio access node to thereby cause the radio access node to transmit a RTS frame within a TDD radio frame on a cell served by the radio access node in an unlicensed frequency band and transmit a downlink transmission to a wireless communication device or receive an uplink transmission from the wireless communication device, on the cell served by the radio access node in the unlicensed spectrum during a period of time that corresponds to a duration of time indicated in the RTS frame.

Embodiments of a method of operation of a wireless communication device are also disclosed. In one embodiment, a method of operation of a wireless communication device comprises receiving a RTS frame within a TDD radio frame of a cell in an unlicensed frequency band, where the cell is served by a radio access node of a cellular communications system. The method further comprises, responsive to receiving the RTS frame, transmitting a CTS frame within the TDD radio frame of the cell.

In one embodiment, receiving the RTS frame comprises receiving the RTS frame during a special slot of an uplink/downlink frame structure of the TDD radio frame. In another embodiment, receiving the RTS frame comprises receiving the RTS frame during a guard period of a special slot of an uplink/downlink frame structure of the TDD radio frame. In one embodiment, transmitting the CTS frame comprises transmitting the CTS frame during the special slot.

In one embodiment, the wireless communication device is an intended recipient of the RTS frame.

In one embodiment, the method further comprises receiving a downlink transmission from the radio access node on the cell or transmitting an uplink transmission to the radio access node on the cell, during a period of time that corresponds to a duration of time indicated in the RTS frame.

In one embodiment, the wireless communication device is not an intended recipient of the RTS frame.

Corresponding embodiments of a wireless communication device are also disclosed. In one embodiment, a wireless communication device is adapted to receive a RTS frame within a TDD radio frame of a cell in an unlicensed frequency band, where the cell is served by a radio access node of a cellular communications system. The wireless communication device is further adapted to, responsive to receiving the RTS frame, transmit a CTS frame within the TDD radio frame of the cell.

In one embodiment, a wireless communication device comprises one or more transmitters, one or more receivers, and processing circuitry associated with the one or more transmitters and the one or more receivers. The processing circuitry is configured to cause the wireless communication device to receive a RTS frame within a TDD radio frame of a cell in an unlicensed frequency band, where the cell is served by a radio access node of a cellular communications system. The processing circuitry is further configured to cause the wireless communication device to, responsive to receiving the RTS frame, transmit a CTS frame within the TDD radio frame of the cell.

Embodiments of a computer program are disclosed in which the computer program comprises instructions which, when executed on at least one processor, cause the at least one processor to carry out the method of operation of a wireless communication device according to any of the embodiments disclosed herein. Embodiments of a carrier containing the computer program are also disclosed, wherein the carrier is one of an electronic signal, an optical signal, a radio signal, or a computer readable storage medium.

In one embodiment, a non-transitory computer readable medium comprises instructions executable by processing circuitry of wireless communication device to thereby cause the wireless communication device to receive a RTS frame within a TDD radio frame of a cell in an unlicensed frequency band, where the cell is served by a radio access node of a cellular communications system and, responsive to receiving the RTS frame, transmit a CTS frame within the TDD radio frame of the cell.

Embodiments of a method of operation of an unlicensed device are also disclosed. In one embodiment, a method of operation of an unlicensed device that operates in a wireless network in unlicensed spectrum in accordance with an unlicensed radio technology comprises detecting a cellular communications system that is using a same frequency band as the wireless network or a frequency band that overlaps with a frequency band used by the wireless network, based on one or more known characteristics of a signal transmitted by network nodes in a radio access network of the cellular communications system. The method further comprises performing one or more actions that mitigate interference cause to the cellular communications system responsive to detecting the cellular communications system.

In one embodiment, the one or more known characteristics of the signal comprise a pulse width and a pulse repetition factor of the signal transmitted by the network nodes in the radio access network of the cellular communications system.

In one embodiment, the signal transmitted by the network nodes in the radio access network of the cellular communications system is a discovery reference signal, and the one or more known characteristics comprise a length of the discovery reference signal and a periodicity of the discovery reference signal.

In one embodiment, the one or more actions comprise: (a) switching to a new frequency channel, (b) activating a clear to send/request to send functionality of the unlicensed device, (c) lowering a transmission power of the unlicensed device, or (d) a combination of any two or more of (a)-(c).

Corresponding embodiments of an unlicensed device are also disclosed. In one embodiment, an unlicensed device for operation in a wireless network in unlicensed spectrum in accordance with an unlicensed radio technology is adapted to detect a cellular communications system that is using a same frequency band as the wireless network or a frequency band that overlaps with a frequency band used by the wireless network, based on one or more known characteristics of a signal transmitted by network nodes in a radio access network of the cellular communications system. The unlicensed device is further adapted to perform one or more actions that mitigate interference cause to the cellular communications system responsive to detecting the cellular communications system.

In one embodiment, an unlicensed device for operation in a wireless network in unlicensed spectrum in accordance with an unlicensed radio technology comprises one or more transmitters, one or more receivers, and processing circuitry associated with the one or more transmitters and the one or more receivers. The processing circuitry is configured to cause the unlicensed device to detect a cellular communications system that is using a same frequency band as the wireless network or a frequency band that overlaps with a frequency band used by the wireless network, based on one or more known characteristics of a signal transmitted by network nodes in a radio access network of the cellular communications system. The processing circuitry is further configured to cause the unlicensed device to perform one or more actions that mitigate interference cause to the cellular communications system responsive to detecting the cellular communications system.

In one embodiment, a non-transitory computer readable medium comprises instructions executable by processing circuitry of wireless communication device to thereby cause the wireless communication device to detect a cellular communications system that is using a same frequency band as the wireless network or a frequency band that overlaps with a frequency band used by the wireless network, based on one or more known characteristics of a signal transmitted by network nodes in a radio access network of the cellular communications system, and perform one or more actions that mitigate interference cause to the cellular communications system responsive to detecting the cellular communications system.

In another embodiment, a method of operation of an unlicensed device that operates in a wireless network in unlicensed spectrum in accordance with an unlicensed radio technology comprises detecting a RTS frame that comprises an indication of a duration of time for which deferred transmission is requested and an indication of an intended recipient of the RTS frame, wherein the unlicensed device is not the intended recipient of the RTS frame. The method further comprises transmitting a CTS frame responsive to detecting the RTS even though the unlicensed device is not the intended recipient of the RTS frame and refraining from transmitting for the duration of time indicated in the RTS frame.

In one embodiment, an unlicensed device for operation in a wireless network in unlicensed spectrum in accordance with an unlicensed radio technology is adapted to detect a RTS frame that comprises an indication of a duration of time for which deferred transmission is requested and an indication of an intended recipient of the RTS frame, wherein the unlicensed device is not the intended recipient of the RTS frame. The unlicensed device is further adapted to transmit a CTS frame responsive to detecting the RTS even though the unlicensed device is not the intended recipient of the RTS frame and refrain from transmitting for the duration of time indicated in the RTS frame.

In one embodiment, an unlicensed device for operation in a wireless network in unlicensed spectrum in accordance with an unlicensed radio technology comprises one or more transmitters, one or more receivers, and processing circuitry associated with the one or more transmitters and the one or more receivers. The processing circuitry is configured to cause the unlicensed device to detect a RTS frame that comprises an indication of a duration of time for which deferred transmission is requested and an indication of an intended recipient of the RTS frame, wherein the unlicensed device is not the intended recipient of the RTS frame. The processing circuitry is further configured to cause the unlicensed device to transmit a CTS frame responsive to detecting the RTS even though the unlicensed device is not the intended recipient of the RTS frame and refrain from transmitting for the duration of time indicated in the RTS frame.

In one embodiment, a non-transitory computer readable medium comprises instructions executable by processing circuitry of wireless communication device to thereby cause the wireless communication device to detect a RTS frame that comprises an indication of a duration of time for which deferred transmission is requested and an indication of an intended recipient of the RTS frame, wherein the unlicensed device is not the intended recipient of the RTS frame, and transmit a CTS frame responsive to detecting the RTS even though the unlicensed device is not the intended recipient of the RTS frame and refrain from transmitting for the duration of time indicated in the RTS frame.

Embodiments of a computer program are disclosed in which the computer program comprises instructions which, when executed on at least one processor, cause the at least one processor to carry out the method of operation of an unlicensed device according to any of the embodiments disclosed herein. Embodiments of a carrier containing the computer program are also disclosed, wherein the carrier is one of an electronic signal, an optical signal, a radio signal, or a computer readable storage medium.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a system in which embodiments of the present disclosure may be implemented;

FIG. 2 illustrates the operation of the system of FIG. 1 in accordance with one embodiment of the present disclosure;

FIG. 3 illustrates an example embodiment in which a radio access node of the cellular communications system transmits a Request To Send (RTS) and receives a Clear to Send (CTS) during a special slot of a Time Division Duplexing (TDD) uplink/downlink frame structure of a TDD radio frame in a cell of the cellular communications system;

FIG. 4 illustrates an example embodiment in which a radio access node of the cellular communications system transmits a RTS during a special slot of a TDD uplink/downlink frame structure of a TDD radio frame in a cell of the cellular communications system;

FIG. 5 illustrate an example in which the radio access node prioritizes transmission of Ultra-Reliable Low-Latency Communication (URLLC) data during a time period that corresponds to a duration of time indicated in a RTS frame transmitted by the radio access node in accordance with one embodiment of the present disclosure;

FIG. 6 is a flow chart that illustrates the operation of a device operating in accordance with an unlicensed radio technology (e.g., the Wi-Fi radio technology) to detect a cellular communications system and perform one or more actions to mitigate interference caused to the cellular communications system in accordance with an embodiment of the present disclosure;

FIGS. 7 through 9 are schematic block diagrams of example embodiments of a radio access node; and

FIGS. 10 and 11 are schematic block diagrams of example embodiments of a wireless communication device.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

For the case of co-existence in unlicensed spectrum, LTE Licensed Assisted Access (LAA) (LTE-LAA) or NR in Unlicensed spectrum (NR-U) has to follow the same rules in unlicensed frequency bands that other radio technologies must follow in the unlicensed frequency bands (see e.g. ERC Rec 70-03, Relating to the use of Short Range Devices (SRD)). This means that, for example, LTE-LAA and NR-U must use adequate spectrum sharing mechanisms such as Listen Before Talk (LBT) and may be subject to power restrictions, which causes problems for some services and coverage scenarios. When operating in unlicensed spectrum, output power of both the radio access node and the UE is limited in order to cause little interference within the unlicensed frequency band and to services operating in adjacent frequency bands. The limited output power leads to a small coverage area. Further, geographical separation and coordination zones may be needed to avoid interference, which is more difficult in unlicensed spectrum as devices operating in unlicensed spectrum are usually low-end consumer products. Deployments in unlicensed spectrum may be restricted to indoor usage to avoid interference to adjacent services. In some cases, a license of the band may be given for some limited areas (e.g., factories, public places like airports, harbor, etc.) and protection of other services which also can use the band has to be ensured.

For the case of co-existence in licensed spectrum, in IMT, cellular operators that have licensed TDD spectrum within the same band may use synchronization to avoid interference, and this may be enforced in the licenses given to the operators or agreements between the operators. The number of operators in a band is limited (e.g., usually limited to a maximum of four operators). A common DL/UL frame structure for the operators sharing the licensed TDD spectrum can be found. In SRD unlicensed, there are individual users, and it would be very difficult to agree upon and enforce such a common DL/UL time structure or change the common DL/UL time structure in in the future as too many parties are involved. One solution is that the SRD device when detecting a local license (authorization) is not allowed to transmit at all or is only allowed to transmit at a substantially reduced power level. For example, this could be done in a coordination zone to bar/block Wi-Fi devices from transmitting. However, for this, the SRD needs Global Positioning System (GPS) functionality, but the SRD is typically a low-cost device and as such is unlikely to be equipped with a GPS receiver.

In light of the discussion above, there are no good solutions allowing unlicensed technology in a licensed band or protecting licensed services when co-existing with unlicensed services in either a licensed band or an unlicensed band. In unlicensed, all services have the same priority and therefore no protection is possible for services which may need high QoS.

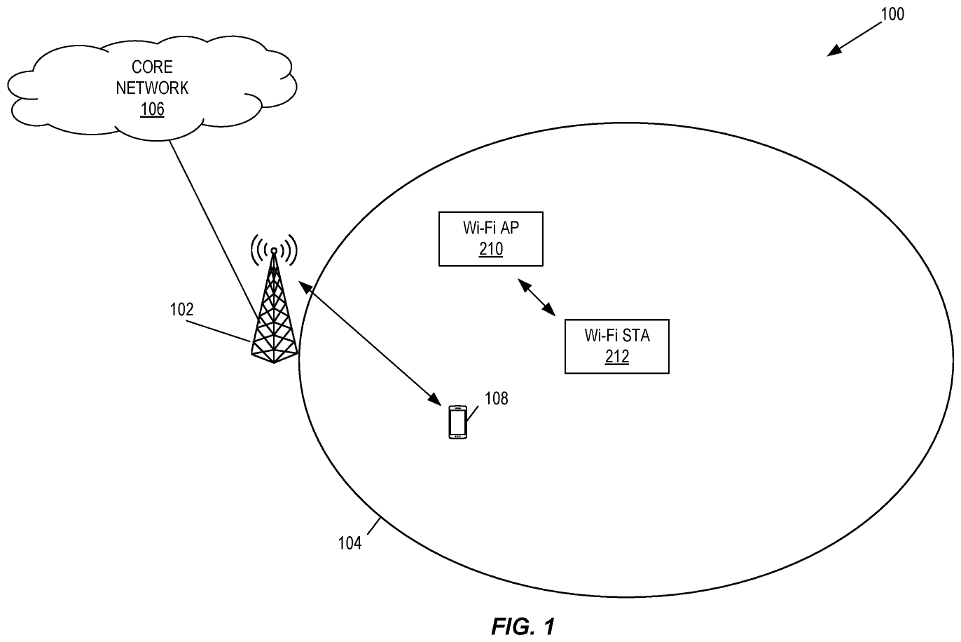

Systems and methods are disclosed herein that enable a licensed service (or higher priority service) and an unlicensed service to operate in the same band and ensure that interference or blocking from the unlicensed service does not cause degradation to the licensed service. In this regard, FIG. 1 illustrates one example of a system 100 in which embodiments of the present disclosure may be implemented. In the embodiments described herein, the system 100 includes a cellular communications system include a Radio Access Network (RAN) including a radio access node 102 serving a cell 104 and a core network 106. In one example, the cellular communications system is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC); however, the embodiments descried herein are not limited thereto. The radio access node 102 provides cellular radio access to a wireless communication device (WCD) 108 on the cell 104.

The cell 104 is provided by the radio access node 102 in an unlicensed frequency band with priority access to certain services. For example, the cell 104 may be provided in an unlicensed frequency band with priority access to certain services within what is generally unlicensed spectrum (e.g., unlicensed frequency band with priority access that is within the 66-71 GHz frequency band that is identified at WRC-2019 for IMT usage or an unlicensed frequency band with priority access that is within the 6 GHz unlicensed spectrum), e.g., in accordance with a geographically limited license (e.g., a license to use the frequency band within a geographic area that corresponds to a factory, a public place such as an airport, a harbor, etc.). In this regard, the unlicensed frequency band with priority access may also be referred to herein as a limited-licensed frequency band. Within the unlicensed frequency band, priority is given to higher priority services provided by the RAN of the cellular communications system (e.g., provided by NG-RAN using NR or NR-U) over services of other unlicensed radio technologies, which in this case include the WiFi radio technology.

Because the cell 104 operates within what is generally unlicensed spectrum, the cell 1104 must co-exist with other radio technologies such as, e.g., the Wi-Fi wireless networking technology or other short-range device (SRD) radio technologies that also operate with the unlicensed spectrum. In this regard, FIG. 1 illustrates a Wi-Fi Access Point (AP) 110 and a Wi-Fi Station (STA) 112 that operate either on the same frequency band as the cell 104, a frequency band that overlaps, at least partially, with the frequency band of the cell 104, or a frequency band that is adjacent to the frequency band of the cell 104.

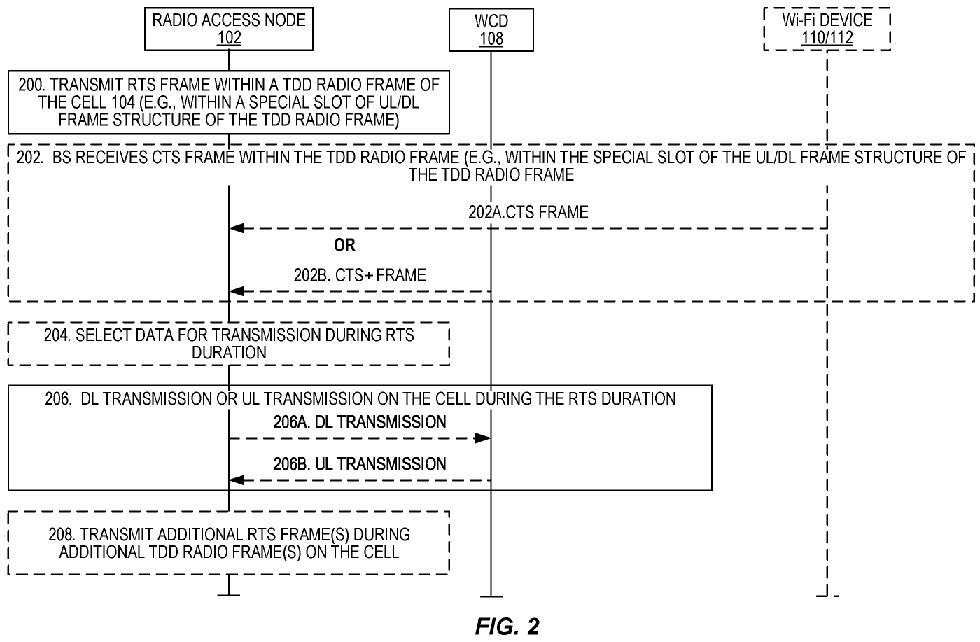

FIG. 2 illustrates the operation of the radio access node 102, the WCD 108, and the Wi-Fi AP and STA 110 and 112 to enable co-existence with the unlicensed radio devices 110 and 112 in accordance with one embodiment of the present disclosure. Note that optional steps are represented by dashed lines/boxes. In this embodiment, the cell 104 is provided by the radio access node 102 in accordance with a Time Division Duplexing (TDD) scheme in which radio frames on the cell 104 have a defined or configured uplink (UL)/downlink (DL) frame structure. The radio frames on the cell 104 are therefore referred to herein as TDD radio frames.

As illustrated, the radio access node 102 transmits, on the cell 104 in the unlicensed frequency band, an IEEE 802.11 Request To Send (RTS) frame within a TDD radio frame on the cell 104 in the unlicensed frequency band (step 200). In one embodiment, the radio access node 102 broadcasts the RTS using the Transmitter

Address (TA) of the RTS as the broadcast address. In one example alternative embodiment, if the WCDs (e.g., WCD 108) can listen to IEEE 802.11 RTS, the radio access node 102 transmits the RTS with the WCD's TA. In IEEE 802.11, the transmission of the RTS has two purposes, namely, (1) to ask the receiver to ensure the channel is free and transmit back a Clear To Send (CTS) that would indicate to the transmitter that it can transmit data packets and (2) to informs all the other unlicensed devices in the range to not transmit for a duration of time indicated in the RTS frame. Currently, in IEEE 802.11 specifications, the RTS can indicate a duration of up to approximately 5.5 milliseconds (ms). Optionally, either one of the Wi-Fi devices (i.e., the Wi-Fi AP 110 or the Wi-Fi STA 112) or, in some embodiments, the WCD 108 transmits a CTS frame responsive to the RTS (step 202; step 202A or step 20213). Notably, the Wi-Fi device(s) refrain from transmitting responsive to receiving the RTS frame from the radio access node 102. Further, in the embodiment in which the Wi-Fi device transmits a CTS frame, the Wi-Fi device may transmit the CTS frame (i.e., a CTS+ frame) even though the Wi-Fi device determines, based on an indication of the intended recipient in the RTS frame, that the Wi-Fi device is not the intended recipient of the RTS frame. This may, for example, enable the radio access node 102 to adapt its transmission (e.g., modulation and coding scheme) based on the number of WiFi devices from which it receives a CTS+ frame.

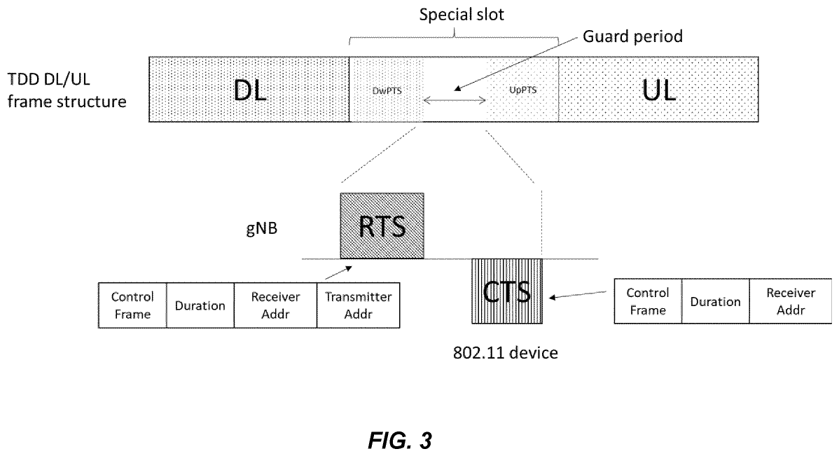

Importantly, the radio access node 102 transmits the RTS within the context of the UL/DL frame structure of the TDD radio frame. As illustrated in FIG. 3, in some embodiment, the RTS is transmitted by the radio access node 102 within a special slot of the TDD UL/DL frame structure of the TDD radio frame. More specifically, in this example, the radio access node 102 transmits the RTS within a guard period within the special slot of the TDD UL/DL frame structure of the TDD radio frame. Further, in this example, a CTS, referred to herein as a CTS+, is transmitted by the either the Wi-Fi AP 110 or the Wi-Fi STA 112 and received by the radio access node 102 during the special slot and, more specifically, within the guard period of the special slot of the TDD UL/DL frame structure of the TDD radio frame. If the CTS+ is received by the radio access node 102, this indicates to the radio access node 102 that there will be no interfering transmission in the unlicensed spectrum for the duration of time indicated in the RTS and, as such, a predicated reliability of an uplink transmission to or a downlink transmission from the radio access node 102 on the cell 104 is increased. Note that the CTS+ transmission is to be distinguished from normal RTS/CTS operation in a conventional Wi-Fi network. In the conventional RTS/CTS, a Wi-Fi device for whom the RTS is not intended does not respond with a CTS but does defer any transmissions for the duration of time indicated in the RTS. Conversely, for CTS+, the Wi-Fi device is not the intended recipient of the RTS transmitted by the radio access node 102, but the Wi-Fi device nevertheless responds with the CTS+ to thereby indicate to the radio access node 102 that the Wi-Fi device agrees to defer any transmissions for the duration of time indicated in the RTS transmitted by the radio access node 102. Note that, in this example, the Wi-Fi device responds with a CTS+; however, in another embodiment, the UE 108 receives the RTS transmitted by the radio access node 102 and responds with a CTS.

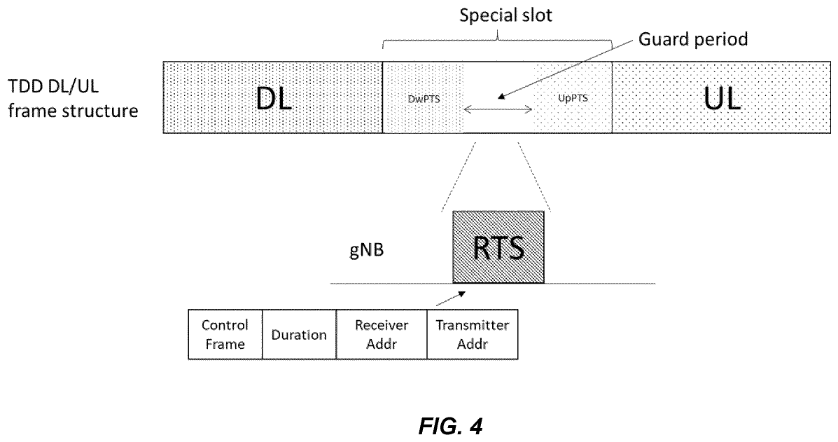

FIG. 4 illustrates another example in which the RTS is transmitted by the radio access node 102 within the special slot of the TDD UL/DL frame structure of the TDD radio frame and, more specifically, within the guard period within the special slot of the TDD UL/DL frame structure of the TDD radio frame. However, in this embodiment, the radio access node 102 does not attempt to receive, or wait, for a CTS before transmitting. Rather, the radio access node 102 assumes that the nearby Wi-Fi devices (e.g., the Wi-Fi AP 110 and the Wi-Fi STA 112) will defer their transmissions for the duration of time indicated in the RTS. In this embodiment, the Wi-Fi device(s) receive the RTS transmitted by the radio access node 102 and, because the Wi-Fi device is not the intended recipient of the RTS, the Wi-Fi does not respond to the RTS but nevertheless refrains from transmitting for the duration of time indicated in the RTS. Returning to FIG. 2, in one embodiment, the CTS frame of step 202 is a conventional IEEE 802.11 CTS frame. However, in another embodiment, the CTS frame is a modified CTS frame, which is referred to herein as a CTS+ frame. More specifically, in this other embodiment, the receiver of the RTS frame of step 200 is a device other than an intended receiver of the RTS frame. For example, a Wi-Fi device (e.g., the Wi-Fi AP 110 or the Wi-Fi STA 112) that transmits the CTS+ frame may not be the intended receiver of the RTS frame. In this case, the CTS+ frame indicates that the Wi-Fi device would not attempt channel access for the duration of time indicated in the RTS. This CTS+ frame can be used as a frame for the devices in the unlicensed network to also not attempt any transmissions that may interfere with the licensed nodes transmissions.

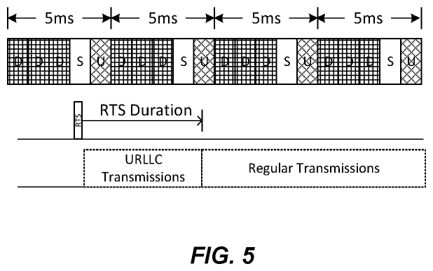

In one embodiment, the duration of time indicated in the RTS frame is equal to a duration, or length, of a TDD radio frame in the cell 104. However, in another embodiment, the duration of time indicated in the RTS frame is less than the duration, or length, of a TDD radio frame in the cell 104. In this case, because the transmission of the RTS frame (and optionally the reception of the CTS or CTS+ frame) increases the predicated reliability of uplink or downlink transmission on the cell 104 during the duration of time indicated in the RTS frame, in one embodiment, the radio access node 102 selects data for uplink transmission to the radio access node 102 from the WCD 108 or downlink transmission from the radio access node 102 to the WCD 108 during the period of time that corresponds to the duration of time indicated in the RTS based on the priority of the data (step 204). For example, the data selected for transmission is data that has a first priority that is higher than a second priority of data that is not selected for transmission during this period of time. As one specific example, the radio access node 102 prioritizes the transmission of data for an Ultra-Reliable Low-Latency Communication (URLLC) service(s) for transmission during the period of time that corresponds to the duration of time indicated in the RTS frame. As example of this is illustrated in FIG. 5 where the RTS duration is approximately 5.5 ms, and the radio access node 102 prioritizes the transmission of URLLC data during the RTS duration since the expected reliability of the transmissions is increased during the RTS duration. After the end of the RTS duration, the radio access node 102 may perform regular transmissions, albeit with lower predicted reliability.

Responsive to transmitting the RTS (and optionally receiving the CTS), either transmits a downlink transmission(s) to the WCD 108 or receives an uplink transmission(s) from the WCD 108 on the cell 104, during a period of time that corresponds to the duration of time indicated in the RTS (step 206A or 206B). Note that such transmissions may also occur after the end of the duration of time indicated in the RTS. However, as discussed above, particularly in scenarios in which the duration indicated in the RTS frame is less than the duration of a TDD radio frame on the cell 104, the data transmitted on the cell 104 during the period of time that corresponds to the duration indicated in the RTS frame is prioritized data such as, e.g., URLLC data.

The radio access node 102 may transmit one or more additional RTS frames in one or more TDD radio frames on the cell 104 (step 108). In one embodiment, the radio access node 102 transmits RTS frames frequently to indicate that the channel is busy and occupied for a certain duration of time. For example, the radio access node 102 may transmit RTS frames periodically (e.g., every “X” ms), where the value of “X” may be predefined, configured, or determined by the radio access node 102. In one example embodiment, the value of “X” is determined by the radio access node 102 based on an amount of high priority data (e.g., URLLC data) to be or expected to be transmitted on the cell 104 and/or an amount of lower priority data (e.g., enhanced Mobile Broadband (eMBB) data) to be or expected to be transmitted on the cell 104. So, for example, if a lot of URLLC data is expected to be transmitted (i.e., if there is a lot of URLLC traffic at the moment), then the radio access node 102 may transmit RTS very frequently (i.e., set X to a small value). Conversely, if there is not a lot of URLLC traffic, the RTS could be transmitted less frequently (i.e., the radio access node 102 may set X to a larger value). Further, either separately or together with adjusting the periodicity (i.e., adjusting the value of “X”), the radio access node 102 may adjust the duration of time indicated in the RTS, e.g., based on the mixture of data to be or expected to be transmitted on the cell 104. For example, as the amount of URLLC data to be transmitted or expected to be transmitted increases, the periodicity of the RTS frames increases and/or the duration of time indicated in the RTS frames increases. In another embodiment, rather than transmitted RTS frames periodically, the radio access node 102 transmits RTS frames on demand (i.e., only when needed to satisfy QoS requirements of the data to be transmitted).

Note that while the embodiments described above focus on IEEE 802.11 protocols and devices, the embodiments described herein may be extended to other radio technologies that operate in unlicensed spectrum and utilize an RTS/CTS mechanism similar to that used in IEEE 802.11.

In the embodiments described above, the radio access node 102 took action to protect transmissions on the cell 104 in the unlicensed frequency band while at the same time providing co-existence with the Wi-Fi devices operating in the unlicensed spectrum. Embodiments will now be described that relate to actions that can be taken by unlicensed devices (e.g., the Wi-Fi AP 110 and/or the Wi-Fi STA 112) to protect transmissions on the cell 104 in the unlicensed frequency band.

In one embodiment, an unlicensed device (e.g., the Wi-Fi AP 110 or the Wi-Fi STA 112) detects the presence of an International Mobile Telecommunications (IMT) system (e.g., the cellular communications system including the radio access node 102 serving the cell 104) that is operating in the same frequency band, an overlapping frequency band, or an adjacent frequency band. In response to detecting the IMT system, the unlicensed device adapts its operation to protect transmissions of the IMT system. For example, the unlicensed device may lower its transmission power, switch its operating channel, or stop transmitting.

Note that, in Europe, harmonization of standards for 5.8 GHz requires in certain countries that an unlicensed device (e.g., an SRD) detects radar stations and, in response to detecting a radar station, switches off or changes its operating channel. In one embodiment of the present disclosure, an unlicensed device (e.g., the Wi-Fi AP 110 or the Wi-Fi STA 112) detects the presence of an IMT system (e.g., the cellular communications system including the radio access node 102 serving the cell 104) using existing radar avoidance and dynamic frequency selection (DFS) features and abandons the channel and selects another operating channel responsive to detecting the IMT system.

An unlicensed device works under master control of an AP (e.g., the Wi-Fi STA 112 works under the control of the Wi-Fi AP 110) which is used in order that the unlicensed device will not transmit in, e.g., countries where the band is not allowed for unlicensed. In one embodiment, this mechanism is used or extended to also protect IMT local areas (e.g., a geographical area to which the licensed used of the unlicensed frequency band by the radio access node 102 for the cell 104 is limited) by, e.g., prohibiting an unlicensed device to operate in such IMT local areas. The master AP in that case is able to detect the presence of the IMT network and will not be allowed to operate under normal unlicensed conditions.

A IMT system (e.g., the cellular communications system including the radio access node 102 serving the cell 104) resembles fixed frequency radar and, in one embodiment, is characterized by pulse width (PW) and pulse repetition frequency (PRF) as shown in Table 1. The corresponding parameters in an IMT system such as a 5GS (including a NR RAN or NG-RAN) or EPS (including an LTE RAN or E-UTRAN) is Discovery Reference Signal (DRS) length and DRS period. For example, the DRS length is typically around 1 ms, and the DRS period typically 20, 40, or 80 ms. When the unlicensed device detects the IMT system (based on the aforementioned DRS length and DRS period), the unlicensed device performs one or more actions including: (a) changes operating channel (Access Points or master control devices), (b) activates its RTS/CTS functionality, (c) lowers its operating or transmission power, or (d) a combination of any two or more of (a)-(c).

TABLE 1

| | | | | | | Pulses per |
|---|---|---|---|---|---|---|
| Radar test | | | Pulse repetition | | | burst for |
| signal # | Pulse width | | frequency PRF | | Number of | each PRF |
| (see note 1 | W (μs) | | (PPS) | | different | (PRB) |
| to note 3) | Min | Max | Min | Max | PRFs | (see note 5) |
| 1 | 0.5 | 5 | 200 | 1 000 | 1 | 10 |
| | | | | | | (see note 6) |
| 2 | 0.5 | 15 | 200 | 1 600 | 1 | 15 |
| | | | | | | (see note 6) |
| 3 | 0.5 | 15 | 2 300 | 4 000 | 1 | 25 |
| 4 | 20 | 30 | 2 000 | 4 000 | 1 | 20 |
| 5 | 0.5 | 2 | 300 | 400 | 2/3 | 10 |
| | | | | | | (see note 6) |
| 6 | 0.5 | 2 | 400 | 1 200 | 2/3 | 15 |
| | | | | | | (see note 6) |

NOTE 1:
Radar test signals #1 to #4 are constant PRF based signals. See FIG. D.1. These radar test signals are intended to simulate also radars using a packet based Staggered PRF. See FIG. D.2.
NOTE 2:
Radar test signal #4 is a modulated radar test signal. The modulation to be used is a chirp Modulation with a ±2.5 MHz frequency deviation which is described below.

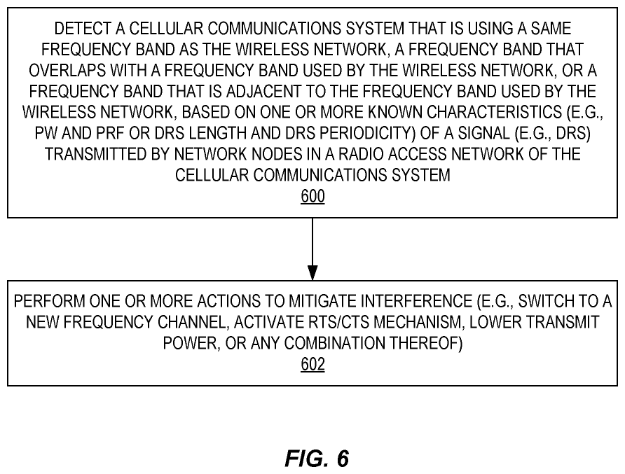

FIG. 6 is a flow chart that illustrates the operation of an unlicensed device in accordance with an embodiment of the present disclosure. The unlicensed device may be, for example, a Wi-Fi device (e.g., the Wi-Fi AP 110 or the Wi-Fi STA 112), but is not limited thereto. As illustrated, the unlicensed device (e.g., the Wi-Fi AP 110 or the Wi-Fi STA 112) of a wireless network (e.g., a Wi-Fi network) detects a cellular communications system (e.g., the cellular communications system including the radio access node 102 serving the cell 104) that is using a same frequency band as the wireless network, a frequency band that overlaps with a frequency band used by the wireless network, or a frequency band that is adjacent to the frequency band used by the wireless network, based on one or more known characteristics of a signal transmitted by network nodes in a radio access network of the cellular communications system (step 600). In one embodiment, the one or more known characteristics of the signal comprise a pulse width and a pulse repetition factor of the signal transmitted by the network nodes in the radio access network of the cellular communications system. In another embodiment, the signal transmitted by the network nodes in the radio access network of the cellular communications system is a discovery reference signal, and the one or more known characteristics comprise a length of the discovery reference signal and a periodicity of the discovery reference signal.

The unlicensed device performs one or more actions that mitigate interference cause to the cellular communications system responsive to detecting the cellular communications system (step 602). In one embodiment, the one or more actions comprise: (a) switching to a new frequency channel, (b) activating a clear to send/request to send functionality of the unlicensed device, (c) lowering a transmission power of the unlicensed device, or (d) a combination of any two or more of (a)-(c).

While the discussion above focuses on Wi-Fi devices as an example of the unlicensed device, the process of FIG. 6 may be performed by other types of unlicensed devices (e.g., any type of SRD that operates in unlicensed spectrum).

As described above, embodiments of the present disclosure provide system and methods to allow unlicensed devices (e.g., a Wi-Fi device or an SRD) limited access to unlicensed spectrum in areas where a licensed IMT system and unlicensed wireless networks or unlicensed devices are operating using the same frequency band, overlapping frequency bands, or adjacent frequency bands. As described above, in one embodiment, this can be achieved by the radio access node 102 operating in the unlicensed frequency band controlling when transmission is allowed by the unlicensed device(s). In one embodiment, a time alignment of the unlicensed device(s) with the cellular network is provided. Focusing on IEEE 802.11 protocol, in one embodiment, the radio access node 102 utilizes the RTS/CTS or similar mechanism. However, other similar mechanisms used in other unlicensed radio technologies may also be used. Thus, in one embodiment, the IMT system (e.g., the radio access node 102) transmits an existing Wi-Fi signal (e.g., a RTS frame) that temporarily prevents Wi-Fi devices that are nearby and operating on the same channel from transmitting.

In another embodiment, an unlicensed device detects the presence of an IMT system and adapt its operation to mitigate interference (e.g., by lowering its output power, switching to a new channel, activating an RTS/CTS mechanism, or any combination thereof). In one embodiment, existing radar detection capability in unlicensed devices (e.g., SRD devices) is extended to include IMT parameters which enables it to detect IMT systems. In another embodiment, unlicensed devices may only operate under master control of an AP, and the AP can be, e.g., GPS enabled knowing the location and exclusion zone where operation is not allowed with full power.

While the embodiments described herein provide numerous advantages, some examples are as follows. Embodiments of the present disclosure may allow regulators to have licensed and unlicensed devices operating in the same spectrum in the same region. License shareholders will be still protected as they have higher priority to use the band. This will also help to protect possible future services in such bands that may need higher protection.

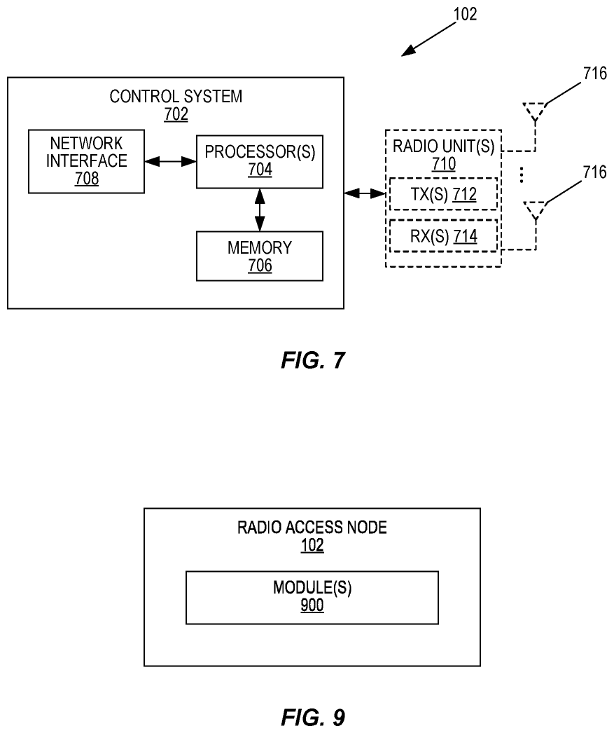

FIG. 7 is a schematic block diagram of the radio access node 102 according to some embodiments of the present disclosure. Optional features are represented by dashed boxes. The radio access node 102 may be, for example, a base station (e.g., a gNB) or a network node that implements all or part of the functionality of a base station. As illustrated, the radio access node 102 includes a control system 702 that includes one or more processors 704 (e.g., Central Processing Units (CPUs), Application Specific Integrated Circuits (ASICs), Field Programmable Gate Arrays (FPGAs), and/or the like), memory 706, and a network interface 708. The one or more processors 704 are also referred to herein as processing circuitry. In addition, the radio access node 102 may include one or more radio units 710 that each includes one or more transmitters 712 and one or more receivers 714 coupled to one or more antennas 716. The radio units 710 may be referred to or be part of radio interface circuitry. In some embodiments, the radio unit(s) 710 is external to the control system 702 and connected to the control system 702 via, e.g., a wired connection (e.g., an optical cable). However, in some other embodiments, the radio unit(s) 710 and potentially the antenna(s) 716 are integrated together with the control system 702. The one or more processors 704 operate to provide one or more functions of the radio access node 102 as described herein (e.g., one or more functions of the radio access node 102 as described herein). In some embodiments, the function(s) are implemented in software that is stored, e.g., in the memory 706 and executed by the one or more processors 704.

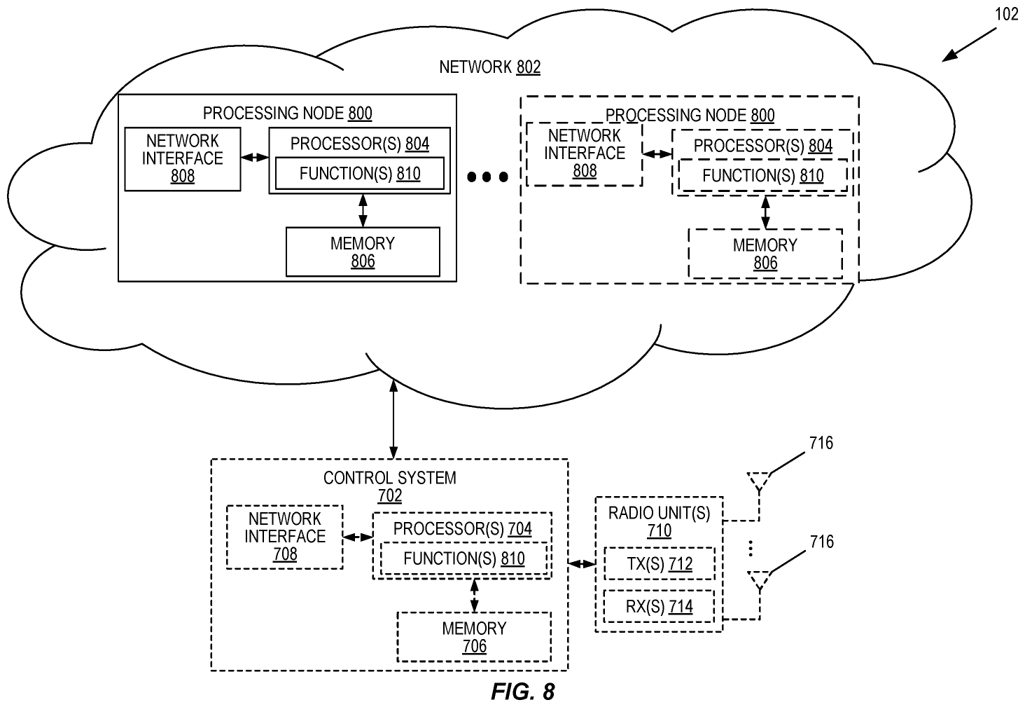

FIG. 8 is a schematic block diagram that illustrates a virtualized embodiment of the radio access node 102 according to some embodiments of the present disclosure. This discussion is equally applicable to other types of network nodes. Further, other types of network nodes may have similar virtualized architectures. Again, optional features are represented by dashed boxes. As used herein, a “virtualized” radio access node is an implementation of the radio access node 102 in which at least a portion of the functionality of the radio access node 102 is implemented as a virtual component(s) (e.g., via a virtual machine(s) executing on a physical processing node(s) in a network(s)). As illustrated, in this example, the radio access node 102 may include the control system 702 and/or the one or more radio units 710, as described above. The control system 702 may be connected to the radio unit(s) 710 via, for example, an optical cable or the like. The radio access node 102 includes one or more processing nodes 800 coupled to or included as part of a network(s) 802. If present, the control system 702 or the radio unit(s) are connected to the processing node(s) 800 via the network 802. Each processing node 800 includes one or more processors 804 (e.g., CPUs, ASICs, FPGAs, and/or the like), memory 806, and a network interface 808.

In this example, functions 810 of the radio access node 102 described herein (e.g., one or more functions of the radio access node 102 as described herein) are implemented at the one or more processing nodes 800 or distributed across the one or more processing nodes 800 and the control system 702 and/or the radio unit(s) 710 in any desired manner. In some particular embodiments, some or all of the functions 810 of the radio access node 102 described herein are implemented as virtual components executed by one or more virtual machines implemented in a virtual environment(s) hosted by the processing node(s) 800. As will be appreciated by one of ordinary skill in the art, additional signaling or communication between the processing node(s) 800 and the control system 702 is used in order to carry out at least some of the desired functions 810. Notably, in some embodiments, the control system 702 may not be included, in which case the radio unit(s) 710 communicate directly with the processing node(s) 800 via an appropriate network interface(s).

In some embodiments, a computer program including instructions which, when executed by at least one processor, causes the at least one processor to carry out the functionality of radio access node 102 or a node (e.g., a processing node 800) implementing one or more of the functions 810 of the radio access node 102 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the radio access node 102 according to some other embodiments of the present disclosure. The radio access node 102 includes one or more modules 900, each of which is implemented in software. The module(s) 900 provide the functionality of the radio access node 102 described herein (e.g., one or more functions of the radio access node 102 as described herein). This discussion is equally applicable to the processing node 800 of FIG. 8 where the modules 900 may be implemented at one of the processing nodes 800 or distributed across multiple processing nodes 800 and/or distributed across the processing node(s) 800 and the control system 702.

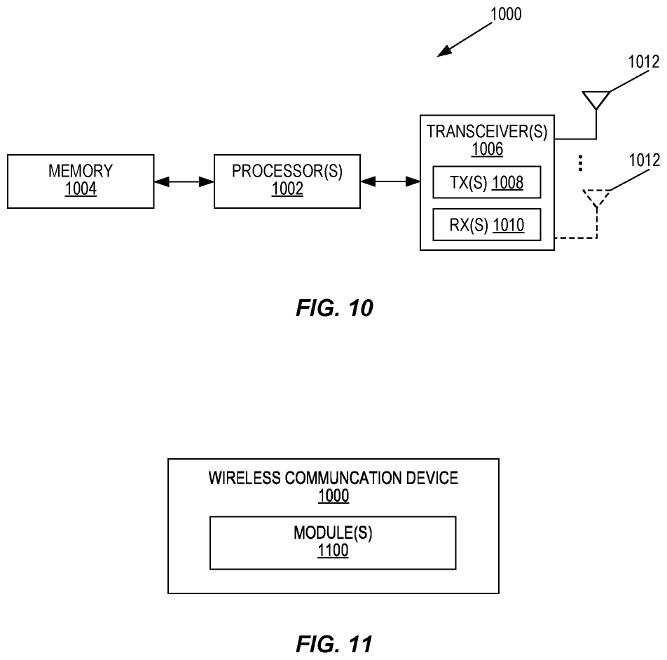

FIG. 10 is a schematic block diagram of a wireless communication device 1000 according to some embodiments of the present disclosure. The wireless communication device 1000 may be the WCD 108 associated to the cellular communications system or an unlicensed device (e.g., the Wi-Fi AP 110 or the Wi-Fi STA 112). As illustrated, the wireless communication device 1000 includes one or more processors 1002 (e.g., CPUs, ASICs, FPGAs, and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the wireless communication device 1000 described above (e.g., one or more functions of the WCD 108 associated to the cellular communications system or an unlicensed device (e.g., the Wi-Fi AP 110 or the Wi-Fi STA 112), as described herein) may be fully or partially implemented in software that is, e.g., stored in the memory 1004 and executed by the processor(s) 1002. Note that the wireless communication device 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the wireless communication device 1000 and/or allowing output of information from the wireless communication device 1000), a power supply (e.g., a battery and associated power circuitry), etc.

In some embodiments, a computer program including instructions which, when executed by at least one processor, causes the at least one processor to carry out the functionality of the wireless communication device 1000 according to any of the embodiments described herein (e.g., one or more functions of the WCD 108 associated to the cellular communications system or an unlicensed device (e.g., the Wi-Fi AP 110 or the Wi-Fi STA 112), as described herein) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the wireless communication device 1000 according to some other embodiments of the present disclosure. The wireless communication device 1000 includes one or more modules 1100, each of which is implemented in software. The module(s) 1100 provide the functionality of the wireless communication device 1000 described herein (e.g., one or more functions of the WCD 108 associated to the cellular communications system or an unlicensed device (e.g., the Wi-Fi AP 110 or the Wi-Fi STA 112), as described herein).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AP Access Point
ASIC Application Specific Integrated Circuit
CPU Central Processing Unit
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
IoT Internet of Things
LTE Long Term Evolution
MTC Machine Type Communication
NR New Radio
OTT Over-the-Top
PC Personal Computer
QoS Quality of Service
RAM Random Access Memory
RAN Radio Access Network
ROM Read Only Memory
RRH Remote Radio Head
UE User Equipment

Those skilled in the art will recognize improvements and modifications to the embodiments of the present disclosure. All such improvements and modifications are considered within the scope of the concepts disclosed herein.

1. A method of operation of a radio access node of radio access network of a cellular communications system, the method comprising:
transmitting a Request to Send, RTS, frame within a Time Division Duplexing, TDD, radio frame on a cell served by the radio access node in an unlicensed frequency band; and
transmitting a downlink transmission to a wireless communication device or receiving an uplink transmission from the wireless communication device, on the cell served by the radio access node in the unlicensed spectrum during a period of time that corresponds to a duration of time indicated in the RTS frame.

2. The method of claim 1 wherein the duration of time indicated in the RTS frame is less than a length of the TDD radio frame on the cell served by the radio access node.

3. The method of claim 2 further comprising selecting data for transmission during the period of time that corresponds to the duration of time indicated in the RTS frame based on priority, wherein the downlink transmission or the uplink transmission is a transmission of the selected data.

4. The method of claim 3 wherein the selected data is data for an Ultra-Reliable Low-Latency Communication, URLLC, service.

5. The method of claim 1 wherein the duration of time indicated in the RTS frame is equal to a length of the TDD radio frame on the cell served by the radio access node.

6. The method of claim 1 wherein transmitting the RTS frame within the TDD radio frame comprises transmitting the RTS frame within a special slot of an uplink/downlink frame structure of the TDD radio frame.

7. The method of claim 1 wherein transmitting the RTS frame within the TDD radio frame comprises transmitting the RTS frame within a guard period within a special slot of an uplink/downlink frame structure of the TDD radio frame.

8. The method of claim 6 further comprising receiving a Clear to Send, CTS, frame during the special slot, wherein transmitting the downlink transmission to the wireless communication device or receiving the uplink transmission from the wireless communication device comprises transmitting the downlink transmission to the wireless communication device or receiving the uplink transmission from the wireless communication device responsive to receiving the CTS frame during the special slot.

9. The method of claim 1 further comprising transmitting one or more additional RTS frames within one or more additional TDD radio frames on the cell served by the radio access node in the unlicensed frequency band.

10. The method of claim 1 further comprising periodically transmitting one or more additional RTS frames within one or more additional TDD radio frames on the cell served by the radio access node in the unlicensed frequency band.

11. The method of claim 1 further comprising periodically transmitting one or more additional RTS frames within one or more additional TDD radio frames on the cell served by the radio access node in the unlicensed frequency band at a particular periodicity, wherein the particular periodicity is based on an amount of data of a first priority that is to be or expected to be transmitted on the cell and/or an amount of data of a second priority that is to be or expected to be transmitted on the cell, the first priority being higher than the second priority.

12. The method of claim 1 wherein the RTS frame is an IEEE 802.11 RTS frame.

13-19. (canceled)

20. A method of operation of a wireless communication device, the method comprising:
receiving a Request to Send, RTS, frame within a Time Division Duplexing, TDD, radio frame of a cell in an unlicensed frequency band, where the cell is served by a radio access node of a cellular communications system; and
responsive to receiving the RTS frame, transmitting a Clear to Send, CTS, frame within the TDD radio frame of the cell.

21. The method of claim 20 wherein receiving the RTS frame comprises receiving the RTS frame during a special slot of an uplink/downlink frame structure of the TDD radio frame.

22. The method of claim 20 wherein receiving the RTS frame comprises receiving the RTS frame during a guard period of a special slot of an uplink/downlink frame structure of the TDD radio frame.

23. The method of claim 21 or 22 wherein transmitting the CTS frame comprises transmitting the CTS frame during the special slot.

24. The method of claim 20 wherein the wireless communication device is an intended recipient of the RTS frame.

25. The method of claim 20 further comprising receiving a downlink transmission from the radio access node on the cell or transmitting an uplink transmission to the radio access node on the cell, during a period of time that corresponds to a duration of time indicated in the RTS frame.

26. The method of claim 20 wherein the wireless communication device is not an intended recipient of the RTS frame.

27-33. (canceled)

34. A method of operation of an unlicensed device that operates in a wireless network in unlicensed spectrum in accordance with an unlicensed radio technology, the method comprising:
detecting a cellular communications system that is using a same frequency band as the wireless network or a frequency band that overlaps with a frequency band used by the wireless network, based on one or more known characteristics of a signal transmitted by network nodes in a radio access network of the cellular communications system; and
performing one or more actions that mitigate interference cause to the cellular communications system responsive to detecting the cellular communications system.

35. The method of claim 34 wherein the one or more known characteristics of the signal comprise a pulse width and a pulse repetition factor of the signal transmitted by the network nodes in the radio access network of the cellular communications system.

36. The method of claim 34 wherein the signal transmitted by the network nodes in the radio access network of the cellular communications system is a discovery reference signal, and the one or more known characteristics comprise a length of the discovery reference signal and a periodicity of the discovery reference signal.

37. The method of claim 34 wherein the one or more actions comprise: (a) switching to a new frequency channel, (b) activating a clear to send/request to send functionality of the unlicensed device, (c) lowering a transmission power of the unlicensed device, or (d) a combination of any two or more of (a)-(c).

38-50. (canceled)

51. The method of claim 20, further comprising:
detecting a Request to Send, RTS, frame that comprises an indication of a duration of time for which deferred transmission is requested and an indication of an intended recipient of the RTS frame, wherein the unlicensed device is not the intended recipient of the RTS frame.

52. The method of claim 51, further comprising:
transmitting a Clear to Send, CTS, frame responsive to detecting the RTS even though the unlicensed device is not the intended recipient of the RTS frame; and
refraining from transmitting for the duration of time indicated in the RTS frame.
